(19) United States
(12) Patent Application Publication
(10) Pub. No.: US 2021/0333148 A1
(43) Pub. Date: Oct. 28, 2021

(54) MEASUREMENT APPARATUS AND MEASUREMENT METHOD

(71) Applicant: SEIKO EPSON CORPORATION, TOKYO (JP)

(72) Inventor: Tomonori MATSUSHITA, Chino-shi (JP)

(21) Appl. No.: 17/238,165

(22) Filed: Apr. 22, 2021

(30) Foreign Application Priority Data
Apr. 24, 2020 (JP) 2020-077204

(51) Int. Cl. G01J 1/42; G01J 1/02

(52) U.S. Cl. CPC G01J 1/4257; G01J 1/0242

(57) ABSTRACT

A measurement apparatus includes a light source that emits light, a spectroscopic element that is configured to transmit light of a predetermined wavelength out of the light emitted from the light source portion, and capable of changing the predetermined wavelength of the light to be transmitted within a predetermined wavelength range, an interference optical system which separates light emitted from the spectroscopic element into measurement light irradiated on a measurement target and reference light reflected by a reference body, and generates interference light obtained by combining the measurement light reflected by the measurement target and the reference light reflected by the reference body, an image sensor that receives the interference light, and one or more processors configured to calculate a position of the measurement target based on spectrum information indicating a change in a received light quantity at the light receiving portion when the predetermined wavelength of the light transmitted through the spectroscopic element is changed.

The present application is based on, and claims priority from JP Application Serial Number 2020-077204, filed Apr. 24, 2020, the disclosure of which is hereby incorporated by reference herein in its entirety.

### BACKGROUND

### 1. Technical Field

The present disclosure relates to a measurement apparatus and a measurement method.

### 2. Related Art

Conventionally, there has been known a measurement apparatus which separates light emitted from a light source into reference light and measurement light, combines the measurement light reflected by an object with the reference light reflected by a reference body to form interference light, and measures a shape of the object and a distance to the object based on a light quantity of the interference light (refer to, for example, JP-A-2018-63153).

In such a measurement apparatus, when an optical path length difference between the measurement light and the reference light is an integer multiple of a wavelength, the light quantity of the interference light reaches the maximum, and when the optical path length difference is not an integer multiple of the wavelength, the light quantity thereof decreases. Therefore, a distance from the measurement apparatus to a measurement point of the object can be calculated or a shape of the object can be measured based on a light intensity of the interference light.

For example, in JP-A-2018-63153, by moving the reference body or an optical system (beam splitter) by a movable portion, the optical path lengths of the measurement light and the reference light are changed, and the shape of the object is measured based on an interference fringe pattern based on the optical path length difference, that is, the received light quantity of the interference light received by a light receiving portion (the light intensity).

That is, in the measurement apparatus using the interference light, when the wavelengths of the measurement light and the reference light are denoted by λ and the optical system is moved toward the object by a moving quantity z, the received light quantity of light received by the light receiving portion reaches a peak value (the maximum). In this case, a relationship between an intensity (received light quantity) I of the light received by the light receiving portion, λ, and z is as shown in the following Expression (1).

When irregularities due to foreign matter or the like exist on a surface of the object and a dimension of the irregularities with respect to a path direction of the measurement light is δ, a relation shown in the following Expression (2) is satisfied.

I∝1+cos{2π/λ×2(z−δ)} (2)

Therefore, by measuring the received light quantity I received by the light receiving portion, it is possible to measure the dimension δ of the irregularities.

However, the related interferometer can measure the dimension δ with high accuracy when the dimension δ of the irregularities is within the wavelength λ, but cannot measure the dimension δ accurately when the dimension δ is larger than the wavelength λ. For example, when the surface of the object has a projection or a hole having a steep gradient in which the optical path length difference varies several times, it is impossible to predict the dimension δ of a height of the projection or a depth of the hole.

### SUMMARY

A first aspect of the present disclosure provides a measurement apparatus which includes a light source portion that emits light, a spectroscopic element that is configured to transmit light of a predetermined wavelength out of the light emitted from the light source portion, and capable of changing the predetermined wavelength of the light to be transmitted within a predetermined wavelength range, an interference optical system which separates light emitted from the spectroscopic element into measurement light irradiated on a measurement target and reference light reflected by a reference body, and generates interference light obtained by combining the measurement light reflected by the measurement target and the reference light reflected by the reference body, a light receiving portion that receives the interference light, and a position calculating unit that calculates a position of the measurement target based on spectrum information indicating a change in a received light quantity at the light receiving portion when the predetermined wavelength of the light transmitted through the spectroscopic element is changed.

A second aspect of the present disclosure provides a measurement method which includes a light source portion that emits light, a spectroscopic element that is configured to transmit light of a predetermined wavelength out of the light emitted from the light source portion, and capable of changing the predetermined wavelength of the transmitted light to be transmitted within a predetermined wavelength range, an interference optical system which separates light emitted from the spectroscopic element into measurement light irradiated on a measurement target and reference light reflected by a reference body, and generates interference light obtained by combining the measurement light reflected by the measurement target and the reference light reflected by the reference body, and a light receiving portion that receives the interference light, the measurement method is characterized by including acquiring spectrum information indicating a change in a received light quantity at the light receiving portion when the predetermined wavelength of the light transmitted through the spectroscopic element is changed, and calculating a position of the measurement target based on the spectrum information.

### BRIEF DESCRIPTION OF THE DRAWINGS

FIG. 1 is a diagram showing a schematic configuration of a measurement apparatus according to a first embodiment.

FIG. 2 is a plan view showing a schematic configuration of a light receiving portion of the first embodiment.

FIG. 3 is a flowchart showing a measurement method of the first embodiment.

FIG. 4 is a diagram showing an example of spectrum information in a reference pixel when a wavelength of light transmitted through a spectroscopic element is changed within a spectral wavelength range in the first embodiment.

FIG. 5 is a flowchart showing details of an operation of step S1 of FIG. 3.

FIG. 6 is a diagram showing an example of spectrum information of interference light when a foreign matter is attached to a measurement target in the first embodiment.

FIG. 7 is a diagram showing a schematic configuration of a measurement apparatus according to a second embodiment.

FIG. 8 is a diagram showing a schematic configuration of a measurement apparatus according to a third embodiment.

FIG. 9 is a diagram showing an example of spectrum information of interference light received by one pixel in the third embodiment.

FIG. 10 is an enlarged view of a part of a wavelength range in FIG. 9.

FIG. 11 is a diagram showing a schematic configuration of an interference optical system according to a modified example 2.

FIG. 12 is a diagram showing a schematic configuration of an interference optical system according to a modified example 3.

### DESCRIPTION OF EXEMPLARY EMBODIMENTS

### First Embodiment

Hereinafter, a measurement apparatus according to a first embodiment will be described.

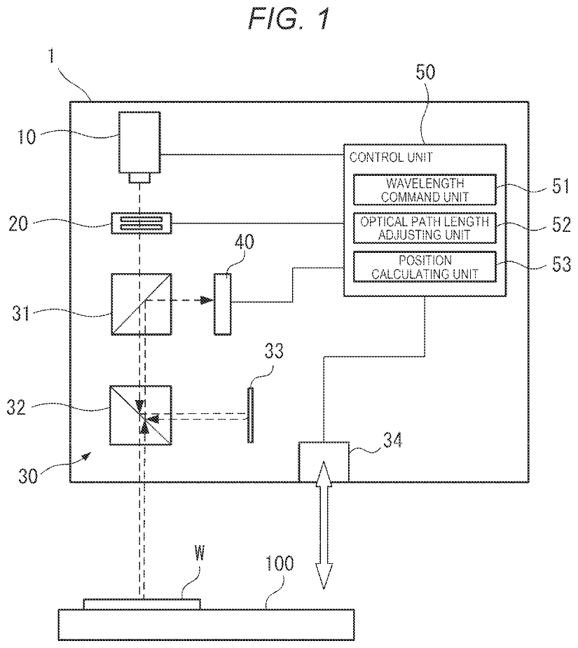

FIG. 1 is a diagram showing a schematic configuration of a measurement apparatus 1 according to a first embodiment.

As shown in FIG. 1, the measurement apparatus 1 of the present embodiment includes a light source portion 10, a spectroscopic element 20, an interference optical system 30, a light receiving portion 40, and a control unit 50.

The light source portion 10 is configured to include a light source that emits light. As the light source, the spectroscopic element 20 may emit light having a uniform light quantity for each wavelength in a spectral wavelength range in which the light can be separated. For example, in the present embodiment, the spectroscopic element 20 defines a spectral wavelength range from a visible light range to a near infrared range, and changes a peak wavelength of light to be transmitted from the spectral wavelength range. In this case, a light source (for example, a halogen lamp) capable of emitting light having a light quantity equal to or larger than a threshold value is used for each wavelength in the spectral wavelength range from the visible light range to the near infrared range.

In the spectroscopic element 20, the light emitted from the light source portion 10 is incident, and the light having a predetermined wavelength is separated and emitted (transmitted). The spectroscopic element 20 is a wavelength-tunable optical element capable of switching the spectral wavelength. In the present embodiment, a wavelength-tunable Fabry-Perot Etalon element is used as the spectroscopic element 20.

The spectroscopic element 20 composed of such a wavelength-tunable Fabry-Perot Etalon element has a pair of mirrors, and a distance between the pair of mirrors (a mirror gap) can be set to a random value by an electrostatic actuator or the like. As a result, the spectroscopic element 20 can transmit light having a wavelength corresponding to the mirror gap.

In the spectroscopic element 20, the spectral wavelength range in which the light can be separated is predetermined, and in the present embodiment, the spectral wavelength range is 400 nm to 1000 nm. The spectral wavelength range is not limited to this, and may include, for example, a range from the ultraviolet range to the infrared range, and only the infrared range may be used as the spectral wavelength range.

In the present embodiment, the Fabry-Perot Etalon element is used as the spectroscopic element 20, but other elements may be used. For example, as the spectroscopic element 20, AOTF (Acousto-Optic Tunable Filter), LCTF (Liquid Crystal Tunable Filter), or the like may be used.

The interference optical system 30 separates the light transmitted through the spectroscopic element 20 into a measurement light toward a measurement target W and a reference light toward a reference body 33, and combines the measurement light reflected by the measurement target W and the reference light reflected by the reference body 33 to generate interference light, which is emitted toward the light receiving portion 40.

Specifically, as shown in FIG. 1, the interference optical system 30 is configured to include a half mirror 31, a beam splitter 32, a reference body 33, and an elevating mechanism 34.

The half mirror 31 transmits the light transmitted through the spectroscopic element 20 in the direction toward the measurement target W, and reflects the light incident from the measurement target W side toward the light receiving portion 40.

The beam splitter 32 splits the light transmitted through the half mirror 31 into the measurement light and the reference light. That is, the beam splitter 32 transmits the measurement light toward the measurement target W and reflects the reference light toward the reference body 33. The beam splitter 32 is, for example, a non-polarizing beam splitter that splits incident light into the measurement light and the reference light at a ratio of 1:1. In addition, the beam splitter 32 transmits the measurement light reflected by the measurement target W, and reflects the reference light reflected by the reference body 33 to combine the measurement light and the reference light to generate the interference light.

The reference body 33 is a mirror that reflects the reference light.

The elevating mechanism 34 is a mechanism for changing the optical path length (measurement optical path length) of the measurement light, and in the present embodiment, the measurement apparatus 1 moves forward and backward with respect to a stage 100 on which the measurement target W is placed. The elevating mechanism 34 exemplifies a configuration in which the entire measurement apparatus 1 is moved forward and backward with respect to the stage 100, but the mechanism is not limited to this. For example, the elevating mechanism 34 may be configured to move the beam splitter 32 and the reference body 33 forward and backward with respect to the stage 100, or to move the stage 100 forward and backward with respect to the measurement apparatus 1.

In the present embodiment, the elevating mechanism 34 changes the optical path length of the measurement optical path, and an example is shown in which the optical path length of the reference optical path is a fixed value.

The light receiving portion 40 receives the interference light that is combined by the beam splitter 32 and reflected by the half mirror.

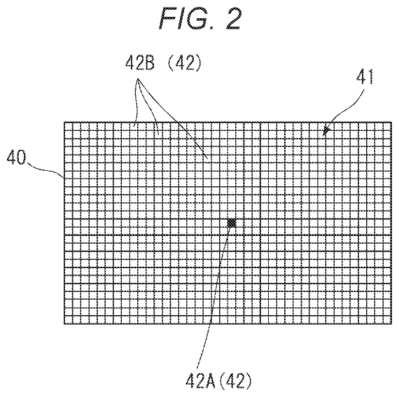

FIG. 2 is a plan view showing a schematic configuration of a light receiving portion 40.

The light receiving portion 40 has a rectangular flat light receiving surface 41 perpendicular to an optical axis of the interference light. In this embodiment, the light receiving portion 40 may be an image sensor. A plurality of pixels 42 are disposed in a matrix shape on the light receiving surface 41. Each pixel 42 has a light receiving sensitivity in the spectroscopic element 20 with respect to a wavelength range (spectral wavelength range) in which the wavelength of transmitted light can be changed, and each pixel 42 outputs a light receiving signal corresponding to the received light quantity by receiving the interference light.

Here, in the following description, one of the plurality of pixels 42 is referred to as a reference pixel 42A, and the other pixel 42 is referred to as a peripheral pixel 42B. The reference pixel 42A is a pixel 42 serving as a measurement reference in the measurement apparatus 1, and for example, among the pixels 42 disposed in a matrix shape, a pixel 42 disposed in the center can be used as the reference pixel 42A. The reference pixel 42A is not limited to the pixel 42 in the center of the light receiving surface 41. For example, among the pixels 42 disposed in a rectangular shape, the pixel 42 disposed at one corner may be used as the reference pixel 42A.

The control unit 50 controls the operation of the measurement apparatus 1 and measures the surface shape of the measurement target W. The control unit 50 may be configured by a computer communicatively connected to the measurement apparatus 1, or may be configured by a microcomputer embedded in the measurement apparatus 1. The control unit 50 is configured to include a storage unit composed of a memory, a hard disk, and the like, and a calculation unit composed of a CPU (Central Processing Unit) and the like. Then, the control unit 50 functions as a wavelength command unit 51, an optical path length adjusting unit 52, and a position calculating unit 53, as shown in FIG. 1, by the calculation unit reading and executing the program stored in the storage unit.

The wavelength command unit 51 controls the spectroscopic element 20 to switch the wavelength of light transmitted through the spectroscopic element 20. For example, in the present embodiment, a Fabry-Perot Etalon element for changing the wavelength of transmitted light by changing the mirror gap due to the electrostatic actuator is used as the spectroscopic element 20. In this case, the wavelength command unit 51 changes the wavelength of the light transmitted from the spectroscopic element 20 by controlling a voltage applied to the electrostatic actuator of the spectroscopic element 20.

The optical path length adjusting unit 52 adjusts an optical path length difference s (=|ls−lr|) that is a difference between the optical path length (measurement optical path length ls) of the measurement optical path and the optical path length of (reference optical path length lr) the reference optical path.

In the present embodiment, the reference optical path length lr is a fixed value. Therefore, the optical path length adjusting unit 52 drives the elevating mechanism 34 to move the measurement apparatus 1 including the interference optical system 30 forward and backward with respect to the stage 100. As a result, the optical path length adjusting unit 52 changes the measurement optical path length ls, thereby changing the optical path length difference s.

The position calculating unit 53 calculates a position of each measurement point of the measurement target W corresponding to each pixel based on the received light quantity of the interference light received by each pixel of the light receiving portion 40, that is, the light receiving signal outputted from each pixel. Specifically, the position calculating unit 53 calculates the position of each measurement point based on spectrum information which is a change in the received light quantity in each pixel obtained by changing the wavelength of light transmitted through the spectroscopic element 20 by the wavelength command unit 51.

The detailed processing of the wavelength command unit 51, the optical path length adjusting unit 52, and the position calculating unit 53 will be described later.

Measurement Method using Measurement Apparatus 1

Next, a measurement method for measuring the surface shape of the measurement target W using the measurement apparatus 1 as described above will be described.

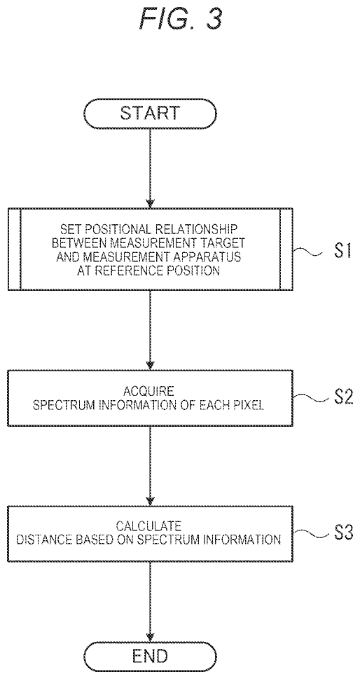

FIG. 3 is a flowchart showing a measurement method of the first embodiment.

In the measurement method using the measurement apparatus 1, first, the optical path length adjusting unit 52 of the measurement apparatus 1 controls the elevating mechanism 34 to set a positional relationship between the measurement apparatus 1 and the measurement target W at the reference position (step S1).

In this step S1, when light of a predetermined reference wavelength is transmitted from the spectroscopic element 20, the elevating mechanism 34 is adjusted such that the received light quantity in the reference pixel 42A of the light receiving portion 40 reaches a peak value (the maximum) and the number of peak wavelengths included in the spectrum information reaches the minimum. In the present embodiment, an example in which the reference wavelength is 480 nm is shown.

That is, when the optical path length difference s satisfies the condition of the following Expression (3), the light quantity of the interference light reaches a peak value because phases of the measurement light and the reference light match.

s=|ls−lr|=nλ (3)

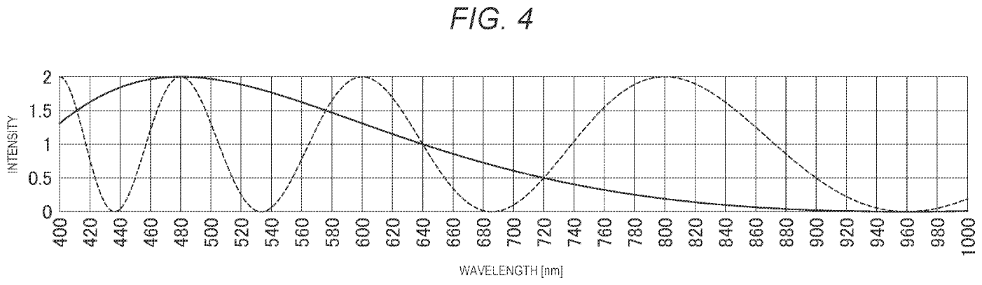

FIG. 4 is a diagram showing an example of spectrum information in the reference pixel 42A when the wavelength of light transmitted through the spectroscopic element 20 is changed within a spectral wavelength range. In FIG. 4, a solid line is spectrum information when a degree n is 1, and a broken line is spectrum information when a degree n is 5.

As shown in FIG. 4, the received light quantity of the interference light reaches a peak value when the optical path length difference s is an integer multiple of the reference wavelength of 480 nm. Here, when the degree n is 1, the peak wavelength is only 480 nm in the spectral wavelength range, but when the degree n is increased, the number of peak wavelengths included in the spectrum information, that is, the number of peak wavelengths in the spectral wavelength range also increases. For example, when the degree n is 5, four peak wavelengths are detected as shown in FIG. 4.

When the number of peaks included in the spectral wavelength range is large, the quantity of change in the received light in the pixel 42 with respect to the change quantity in wavelength is large and a resolution becomes coarse. On the other hand, when the number of peaks included in the spectral wavelength range is small, the change quantity in the received light by the pixel 42 with respect to the change quantity in wavelength is small, and high-resolution measurement can be performed.

Therefore, in step S1, the optical path length adjusting unit 52 adjusts the measurement optical path length ls by controlling the elevating mechanism 34 such that the number of peak wavelengths reaches the minimum value, for example, “1”.

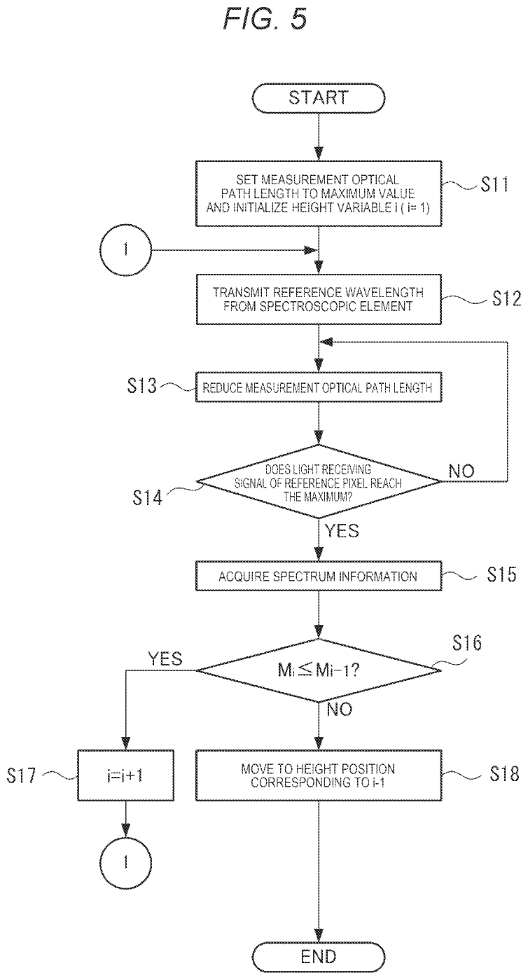

FIG. 5 is a flowchart showing details of an operation of step S1.

In step S1, for example, the optical path length adjusting unit 52 controls the elevating mechanism 34 and moves the measurement apparatus 1 to a position farthest from the measurement target W. That is, the optical path length adjusting unit 52 sets the measurement optical path length ls to the maximum value (step S11). At this time, the optical path length adjusting unit 52 further initializes a height variable i (i=1) for setting the optical path length difference.

Next, the wavelength command unit 51 controls the spectroscopic element 20 to set the wavelength of light transmitted from the spectroscopic element 20 to the reference wavelength of 480 nm, and emits light from the light source portion 10 (step S12). As a result, the light having the reference wavelength is transmitted from the spectroscopic element 20, and the interference light having the reference wavelength is received by the light receiving portion 40.

Thereafter, the optical path length adjusting unit 52 moves the measurement apparatus 1 in the direction close to the stage 100 while referring to the light receiving signal output from the reference pixel 42A of the light receiving portion 40, and reduces the measurement optical path length 1s (step S13).

Then, the optical path length adjusting unit 52 determines whether or not the light receiving signal output from the reference pixel 42A has reached the maximum value (peak value) (step S14). When it is determined as NO in step S14, step S13 is continued until the light receiving signal reaches the maximum value.

When it is determined as YES in step S14, the optical path length adjusting unit 52 stops the elevating mechanism 34 at a height position at which the light receiving signal reaches the maximum value, and the wavelength command unit 51 sequentially switches the wavelength of light transmitted from the spectroscopic element 20 in the spectral wavelength range to acquire spectrum information (step S15). That is, the spectrum information at a position where the optical path length difference s is an integer multiple of the reference wavelength is acquired. In addition, in step S15, the optical path length adjusting unit 52 stores the acquired spectrum information and the height position of the measurement apparatus 1 in the storage unit in association with the height variable i.

Next, the optical path length adjusting unit 52 reads the spectrum information corresponding to the height variable i−1 from the storage unit, and determines whether or not the number of peaks Mᵢ included in the spectrum information of the height variable i is not more than the number of peaks Mᵢ₋₁ included in the spectrum information of the height variable i−1 (step S16).

When it is determined as YES in step S16, 1 is added to the height variable i (step S17), and the process returns to step S12.

On the other hand, when it is determined as NO in step S16, and when the measurement optical path length ls is moved to the minimum value that can be set by the elevating mechanism 34, the optical path length adjusting unit 52 controls the elevating mechanism 34 to move the measurement apparatus 1 to the height position corresponding to the height variable i−1 (step S18).

That is, when the number of peaks Mᵢ is larger than the number of peaks Mᵢ₋₁, it means that the measurement optical path length ls<the reference optical path length lr is obtained, so that the optical path length difference s of the height variable i−1 is the optical path length difference corresponding to the degree of n=1. In addition, when the number of peaks Mᵢ is smaller than the number of peaks Mᵢ₋₁ until the measurement optical path length ls is moved to the minimum value which can be changed by the elevating mechanism 34, the optical path length difference s of the nearest height position where the peak value is obtained in the reference pixel 42A, that is, the height position corresponding to the height variable i−1, is the optical path length difference corresponding to the minimum degree.

As described above, the optical path length difference s is adjusted such that the number of peaks included in the spectrum information is the smallest, that is, the degree n is the smallest.

As described above, after adjustment processing of the optical path length difference in step S1 is performed, the wavelength command unit 51 sequentially switches the wavelength of the light transmitted from the spectroscopic element 20 in the spectral wavelength range, and acquires the spectrum information in all pixels 42 of the light receiving portion 40 (step S2).

Then, the position calculating unit 53 calculates the position of each measurement point of the measurement target W corresponding to each pixel 42, that is, the distance of each measurement point from the measurement apparatus 1, based on the spectrum information (step S3).

Here, a method of calculating the distance of the measurement point from the measurement apparatus 1 in step S3 will be described by comparing related examples.

For example, in a related measurement method as disclosed in JP-A-2018-63153, a laser light having a fixed wavelength is irradiated from a light source, the laser light is separated into measurement light and reference light, and interference light between the measurement light reflected by a measurement target and the reference light reflected by a reference body is obtained. In such a related measurement method, a minute shape within one wavelength of laser light can be measured by using a light receiving signal according to the received light quantity and a differential signal thereof.

However, when the distance between the measurement apparatus and the measurement target changes by an integer multiple of the wavelength, the light intensity of the interference light is the same. Therefore, it is not possible to measure a shape change larger than one wavelength of laser light. When the surface of the measurement target is smoothly changed, the shape can be predicted from the change in the received light quantity of the pixels adjacent to the light receiving portion, but when the surface of the measurement target has a foreign matter or the like and the shape is largely changed, the shape cannot be predicted.

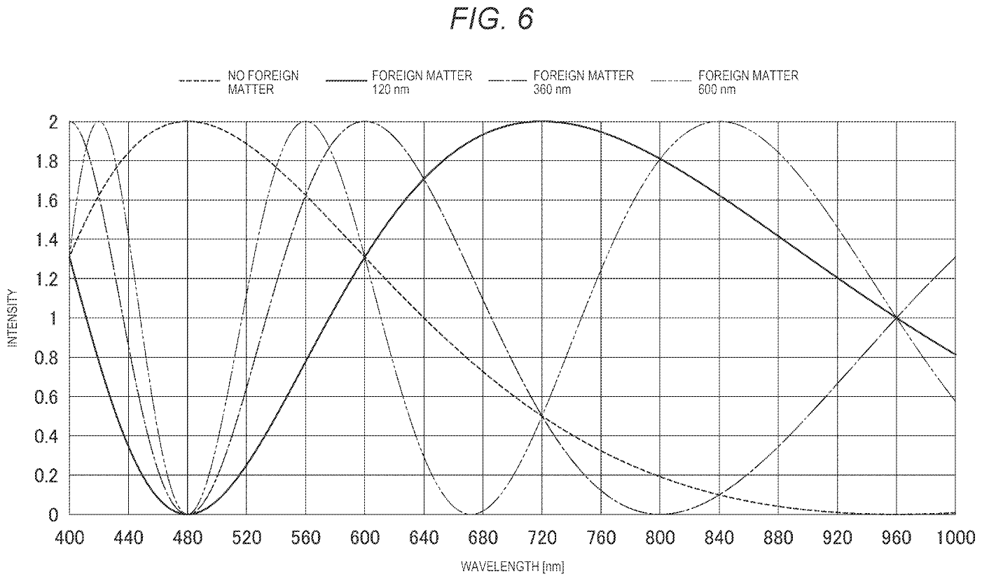

FIG. 6 is a diagram showing an example of the spectrum information of the interference light when the foreign matter is attached to the measurement target W. In FIG. 6, a broken line represents spectrum information when there is no foreign matter, a solid line represents spectrum information of interference light when a foreign matter of 120 nm is attached, a chain line represents spectrum information of interference light when a foreign matter of 360 nm is attached, and a two-dot chain line represents spectrum information of interference light when a foreign matter of 600 nm is attached.

As shown in FIG. 6, when the light of 480 nm is transmitted from the spectroscopic element 20, a light intensity when the foreign matter of 120 nm is attached to the measurement target W, a light intensity when the foreign matter of 360 nm is attached to the measurement target W, and a light intensity when the foreign matter of 600 nm is attached to the measurement target W is all “0”. Therefore, as described above, when only the received light quantity (light intensity) detected by the light receiving portion is used as in the related measurement method, the shape change exceeding one wavelength cannot be measured.

On the other hand, in the present embodiment, the position calculating unit 53 calculates the distance from the measurement apparatus 1 to the measurement target W based on the spectrum information. That is, as shown in FIG. 6, when the size of the foreign matter is different, the light intensities of the interference light at other wavelengths have different values even when the light intensity of the interference light at 480 nm is the same. Therefore, as shown in FIG. 6, spectrum information having different shapes can be obtained depending on the size of the foreign matter.

Therefore, the position calculating unit 53 of the present embodiment calculates the distance from the measurement apparatus 1 of each measurement point of the measurement target W based on the shape of the spectrum information acquired by each pixel 42, that is, the peak wavelength at which the received light quantity reaches a peak value and a peak interval between the peak wavelengths.

That is, the position calculating unit 53 can detect each peak wavelength at which the received light quantity reaches the peak value by acquiring the spectrum information of each pixel 42, and can calculate the degree n in the above-mentioned Expression (3) from each peak wavelength and peak interval. As a result, the position calculating unit 53 can calculate the optical path length difference s of the interference light received by each pixel 42. In addition, in the present embodiment, since the reference optical path length lr is a fixed value, the measurement optical path length ls can be easily calculated from the optical path length difference s. Since the measurement optical path length ls is twice the distance from the beam splitter 32 in the interference optical system 30 to the measurement point corresponding to each pixel 42 of the measurement target W, the distance from the measurement apparatus 1 to each measurement point of the measurement target W can be calculated from the measurement optical path length ls.

That is, in the present embodiment, in step S1, the measurement apparatus 1 and the measurement target W are aligned such that the optical path length difference s at the reference point of the measurement target W corresponding to the reference pixel 42A is an integer multiple of the reference wavelength λ. In addition, in step S2, the spectrum information of each pixel 42 including the peripheral pixel 42B is acquired by changing the wavelength of the light transmitted by the spectroscopic element 20. As a result, in step S3, the position calculating unit 53 can calculate the distance from the measurement apparatus 1 with high accuracy with respect to the reference point of each measurement point based on the distance of the reference point of the measurement target W from the measurement apparatus 1.

Therefore, the position of each measurement point with respect to the reference point in the measurement target W can also be calculated with high accuracy, and surface shapes such as irregularities and an inclination state of the measurement target W can be measured with high accuracy from the position of each measurement point.

In addition, in the present embodiment, a distance Δh from the measurement apparatus 1 to each measurement point of the measurement target W can be calculated by the following Expression (4).

Δh=∂h/∂z×Δz+∂h/∂λ×Δλ (4)

In Expression (4), ∂h/∂z of the first term is a resolution when the elevating mechanism 34 moves the measurement apparatus 1 forward and backward with respect to the stage 100, and ∂h/∂λ of the second term is a resolution when the wavelength of light transmitted through the spectroscopic element 20 is changed. In the related measurement method, since the wavelength λ is fixed, there is no second term, and the measurement is performed with the resolution of only the first term. On the other hand, in the present embodiment, by handling a physical quantity independently in the first and second terms, it is possible to measure with higher accuracy than in the related case.

### Action Effect of Present Embodiment

The measurement apparatus 1 according to the present embodiment includes the light source portion 10 that emits light, the spectroscopic element 20 that can transmit light of a predetermined wavelength from the light emitted from the light source portion 10, and change a wavelength of the light to be transmitted within a predetermined wavelength range, the interference optical system 30 which separates light emitted from the spectroscopic element 20 into the measurement light irradiated on the measurement target W and the reference light reflected by the reference body 33, and generates interference light obtained by combining the measurement light reflected by the measurement target W and the reference light reflected by the reference body 33, the light receiving portion 40 that receives the interference light, and the position calculating unit 53 that calculates a position of the measurement target W based on spectrum information indicating a change in a received light quantity at the light receiving portion 40 when the wavelength of the light transmitted through the spectroscopic element 20 is changed.

That is, in the present embodiment, the wavelengths of the measurement light and the reference light are changed to acquire the received light quantity of the interference light for each wavelength, thereby acquiring the spectrum information indicating the relationship between the wavelength and the received light quantity.

A condition under which the light quantity of the interference light received by the light receiving portion 40 reaches a peak is as shown in Expression (3), and the light quantity of the interference light reaches a peak at a plurality of optical path length differences s of different degrees n. Therefore, when the interference light is measured using only the light of a specific wavelength, the optical path length difference s due to the difference of the degree n cannot be detected. On the other hand, in the present embodiment, the spectrum information of the interference light received by the light receiving portion 40 may include a plurality of peak wavelengths, and when the peak wavelengths and the peak intervals are detected, the degree n can be calculated, and the optical path length difference s can be accurately calculated. Therefore, even when a foreign matter larger than the wavelength of the interference light is attached to the measurement target W, when irregularities are formed in the measurement target W, or when there is a steep gradient in the measurement target W, the size of the foreign matter and irregularities and the gradient of the measurement target W can be calculated with high accuracy.

The measurement apparatus 1 of the present embodiment further includes the optical path length adjusting unit 52 for adjusting the optical path length difference between the measurement light and the reference light. Then, the optical path length adjusting unit 52 adjusts the optical path length difference s such that the number of peak wavelengths included within the wavelength range of the spectrum information (within the spectral wavelength range) reaches the minimum.

When the number of peaks included in the spectral wavelength range reaches the minimum, it means that the degree n is set to the minimum value. For example, when the optical path length difference s is adjusted to 480 nm, when the wavelength of light transmitted through the spectroscopic element 20 is 480 nm, the received light quantity reaches a peak in the light receiving portion 40, but other peak wavelengths do not appear in the spectral wavelength range. The peak wavelength in such spectrum information can be detected with high accuracy, and the measurement accuracy can be improved. That is, ∂h/∂λ of the second term in Expression (4) becomes small, and the distance from the measurement apparatus 1 to the measurement target W can be calculated with high resolution.

In the present embodiment, the optical path length adjusting unit 52 changes a measurement distance, which is the distance between the interference optical system 30 and the measurement target W.

Specifically, the measurement apparatus 1 includes the elevating mechanism 34 for moving the measurement apparatus 1 including the interference optical system 30 forward and backward with respect to the stage 100 on which the measurement target W is placed. Then, the optical path length adjusting unit 52 controls the elevating mechanism 34 to change the measurement optical path length ls while fixing the reference optical path length lr.

In this way, by changing the measurement optical path length ls while fixing the reference optical path length lr, the measurement optical path length ls can be accurately obtained from the value of the optical path length difference s calculated by the position calculating unit 53. Since the measurement optical path length ls is a distance until the measurement light emitted from the beam splitter 32 is reflected by the measurement target W and returns to the beam splitter 32, a half value of the measurement optical path length ls can be calculated as a distance from the beam splitter 32 to the measurement target W.

In the measurement apparatus 1 of the present embodiment, the light receiving portion 40 has a plurality of pixels 42. Then, the optical path length adjusting unit 52 uses one among the plurality of pixels 42 as a reference pixel 42A, and changes the optical path length difference to a position where the received light quantity reaches a peak when the reference pixel 42A receives light of a predetermined reference wavelength (for example, 480 nm).

Thereby, the position of each measurement point corresponding to the peripheral pixel 42B can be accurately calculated with respect to the reference point of the measurement target W corresponding to the reference pixel 42A. In addition, by setting the optical path length difference such that the degree n reaches the minimum value (for example, “1”) in the spectrum information of the reference pixel 42A, a spectrum shape of the spectrum information greatly changes with respect to the spectrum information of the reference pixel 42A when there is a shape change such as a foreign matter or irregularities at a measurement point with respect to the other peripheral pixels 42B. That is, when there is a shape change due to a foreign matter or the like at each measurement point of the measurement target W, the spectrum information of each peripheral pixel 42B shows a significant change in the position of the peak wavelength and the peak interval with respect to the spectrum information of the reference pixel 42A. Therefore, a distance of each measurement point of the measurement target W from the measurement apparatus 1 can be calculated with high resolution, and a surface shape of the measurement target W can be measured with high accuracy based on the distance.

### Second Embodiment

Next, the second embodiment will be described.

In the first embodiment, the measurement apparatus 1 has the elevating mechanism 34, and the elevating mechanism 34 moves the measurement apparatus 1 forward and backward with respect to the stage 100, thereby changing the measurement optical path length ls.

On the other hand, the present embodiment is different from the first embodiment in that the reference optical path length lr is changed. In the following description, the configurations already described will be designated by the same reference numerals, and the description thereof will be omitted or simplified.

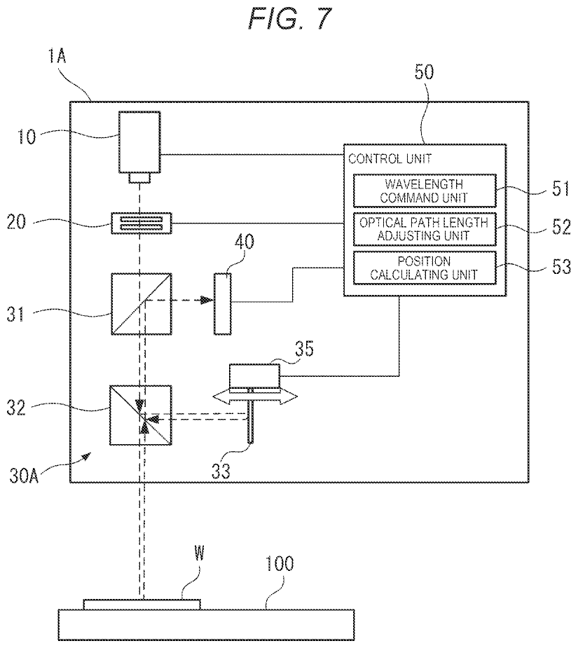

FIG. 7 is a diagram showing a schematic configuration of a measurement apparatus 1A of the present embodiment.

Similar to the first embodiment, the measurement apparatus 1A of the present embodiment includes the light source portion 10, the spectroscopic element 20, an interference optical system 30A, the light receiving portion 40, and the control unit 50.

Here, the interference optical system 30A of the present embodiment is configured to include the half mirror 31, the beam splitter 32, the reference body 33, and a reference body moving mechanism 35.

The reference body moving mechanism 35 is a mechanism for moving the reference body 33 forward and backward with respect to the beam splitter 32.

That is, in the present embodiment, the measurement optical path length ls cannot be changed while the measurement target W is placed on the stage 100, and instead, the reference optical path length lr can be changed by moving the reference body 33 forward and backward with respect to the beam splitter 32.

In such a present embodiment, the surface shape of the measurement target W can be measured by a measurement method substantially the same as that of the first embodiment.

In the present embodiment, in step S1, the optical path length adjusting unit 52 controls the reference body moving mechanism 35 to adjust a position of the reference body 33 with respect to the beam splitter 32. For example, in step S11, the reference body 33 is moved to a position farthest from the beam splitter 32, and in step S13, the reference body 33 is moved toward the beam splitter 32. As a result, when the reference pixel 42A receives the interference light of the reference wavelength by the same processing as in the first embodiment, the reference body 33 is moved to a position where the received light quantity reaches a peak and the degree n reaches the minimum.

Since the subsequent processing is the same as that of the first embodiment, the description thereof will be omitted.

In the measurement apparatus 1A of the present embodiment, the optical path length adjusting unit 52 changes the optical path length of the reference light.

Specifically, the measurement apparatus 1A includes the reference body moving mechanism 35 for changing a distance between the beam splitter 32 and the reference body 33 of the interference optical system 30A. Then, the optical path length adjusting unit 52 controls the reference body moving mechanism 35 to change the reference optical path length lr while fixing the measurement optical path length ls.

In this way, by changing the reference optical path length lr while fixing the measurement optical path length ls, the measurement optical path length ls can be accurately obtained from the value of the optical path length difference s calculated by the position calculating unit 53. That is, the reference optical path length lr can be calculated from the moving quantity of the reference body 33, and the measurement optical path length ls and the distance from the beam splitter 32 to the measurement target W can be calculated based on the optical path length difference s and the calculated reference optical path length lr.

### Third Embodiment

In the first and second embodiments described above, in step S1, the optical path length difference s is adjusted such that the received light quantity of interference light of the reference wavelength received by the reference pixel 42A reaches a peak.

On the other hand, the third embodiment is different from the first and second embodiments in that the shape of the measurement target W is measured without adjusting the optical path length difference by the optical path length adjusting unit 52.

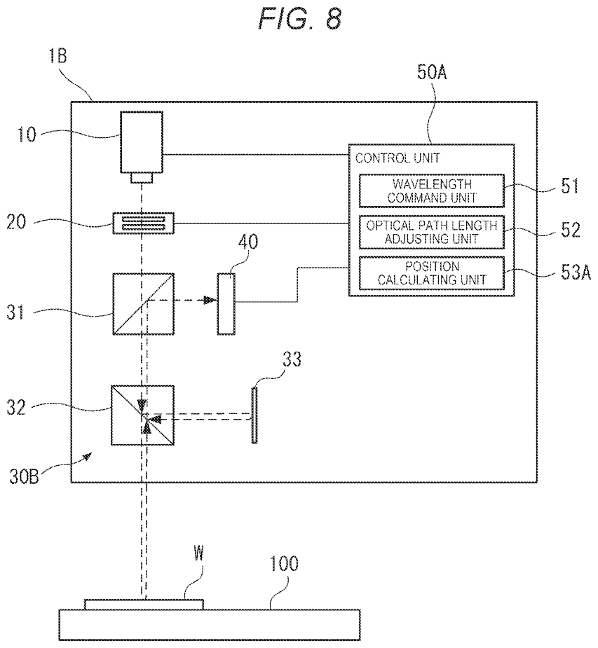

FIG. 8 is a diagram showing a schematic configuration of a measurement apparatus 1B of the present embodiment.

As shown in FIG. 8, the measurement apparatus 1B of the present embodiment includes the light source portion 10, the spectroscopic element 20, an interference optical system 30B, the light receiving portion 40, and a control unit 50A.

As shown in FIG. 8, the interference optical system 30B of the present embodiment includes the half mirror 31, the beam splitter 32, and the reference body 33, but is not provided with the elevating mechanism 34 or the reference body moving mechanism 35.

In addition, the control unit 50A of the present embodiment functions as the wavelength command unit 51 and a position calculating unit 53A.

In the present embodiment, the position calculating unit 53A calculates the position of the measurement point corresponding to each pixel by using only the spectrum information. Here, in the present embodiment, the optical path length difference s may set to a relatively large value equal to or larger than a predetermined value. That is, in the present embodiment, the optical path length difference s between the measurement optical path length ls and the reference optical path length lr is set in advance such that the degree n in Expression (3) takes a relatively large value, for example, n=100 or more.

Specifically, in the measurement apparatus 1B according to the present embodiment, the processing of step S1 is omitted, the measurement target W is placed on the stage 100, and then the processing of step S2 is performed to acquire the spectrum information of each pixel 42.

After that, in step S3, the position calculating unit 53A measures a position of each measurement point using the spectrum information for each pixel 42. Here, in the present embodiment, as described above, the optical path length difference s is equal to or larger than a predetermined value, and the degree n is, for example, a higher degree of 100th or higher.

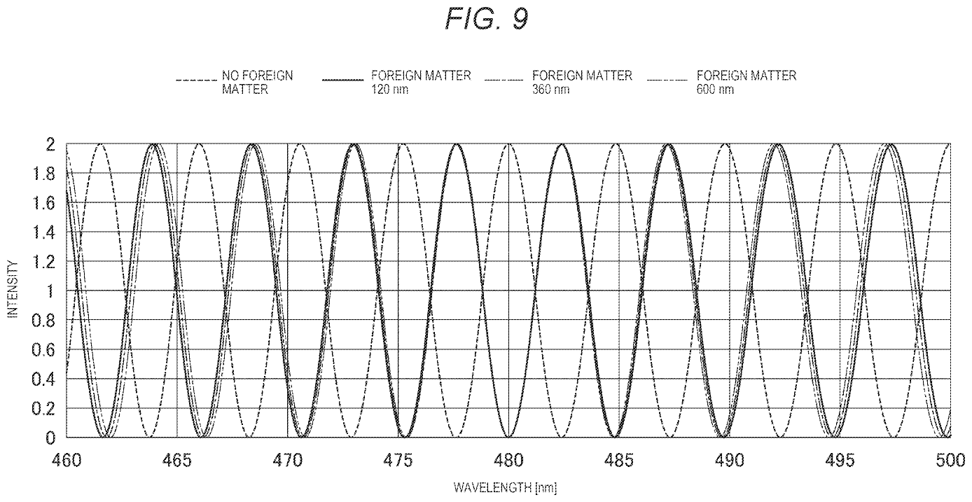

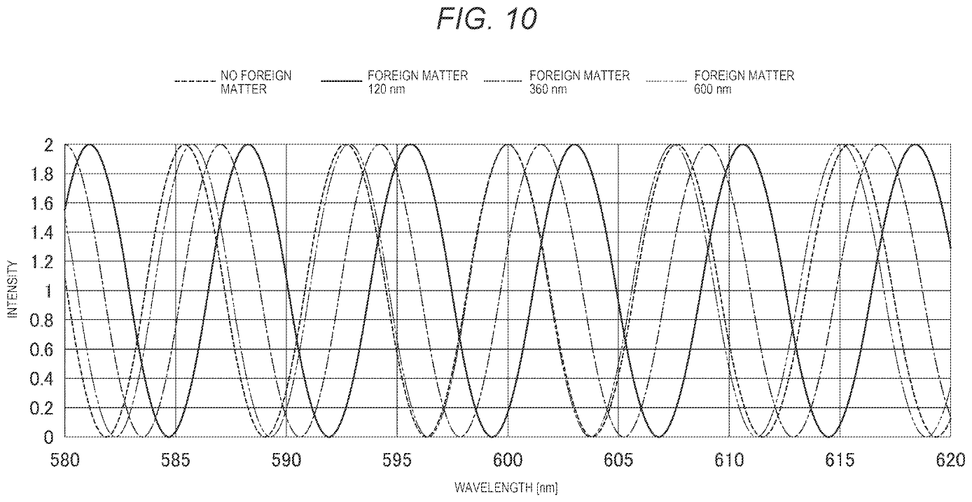

FIG. 9 and FIG. 10 are diagrams showing an example of the spectrum information of the interference light received by one pixel 42 in the present embodiment. In FIG. 9 and FIG. 10, broken lines represent spectrum information when there is no foreign matter, solid lines represent spectrum information when a foreign matter of 120 nm is attached, chain lines represent spectrum information when a foreign matter of 360 nm is attached, and two-dot chain lines represent spectrum information when a foreign matter of 600 nm is attached.

When n is higher degree, as shown in FIG. 9 and FIG. 10, a plurality of peak wavelengths appear in a narrow wavelength range, and even when a plurality of types of foreign matters having different sizes are attached as shown in FIG. 9, the same peak wavelength may be detected. However, referring to other wavelength ranges in the spectrum information, it can be seen that the peak wavelengths differ depending on the type of foreign matter, as shown in FIG. 10. Therefore, the position calculating unit 53A can calculate the distance from the measurement apparatus 1B of each measurement point of the measurement target W corresponding to each pixel 42 by detecting the peak wavelength of each spectrum information and the peak interval.

In the present embodiment, since the elevating mechanism 34 and the reference body moving mechanism 35 are not provided, vibration when driving the elevating mechanism 34 and the reference body moving mechanism 35 does not occur. Accordingly, a measurement error based on the vibration does not occur, and the measurement accuracy can be improved. In addition, since it is not necessary to provide a high-resolution moving mechanism as the elevating mechanism 34 or the reference body moving mechanism 35, the cost of the measurement apparatus 1B can be reduced and the measurement apparatus 1B can be miniaturized.

### MODIFIED EXAMPLE

The present disclosure is not limited to the above-described embodiment, and modifications, improvements, and the like within the range in which the object of the present disclosure can be achieved are included in the present disclosure.

### Modified Example 1

In the first embodiment and the second embodiment, after adjusting the optical path length difference s in step S1, the wavelength of the light transmitted through the spectroscopic element 20 is changed in step S2 to acquire spectrum information for each pixel 42.

On the other hand, in step S14 and step S15 of step S1, not only the reference pixel 42A but also the spectrum information of the peripheral pixel 42B may be acquired. In this case, the processing of step S2 can be omitted.

### Modified Example 2

In the above embodiment, the half mirror 31 of the interference optical system 30 transmits the light transmitted through the spectroscopic element 20 toward the beam splitter 32, and reflects the interference light incident from the beam splitter 32 side toward the light receiving portion 40. On the other hand, the half mirror 31 may be configured such that the light transmitted through the spectroscopic element 20 is reflected toward the beam splitter 32, and the interference light incident from the beam splitter 32 side is transmitted toward the light receiving portion 40.

In addition, a polarizing beam splitter may be used instead of the half mirror 31.

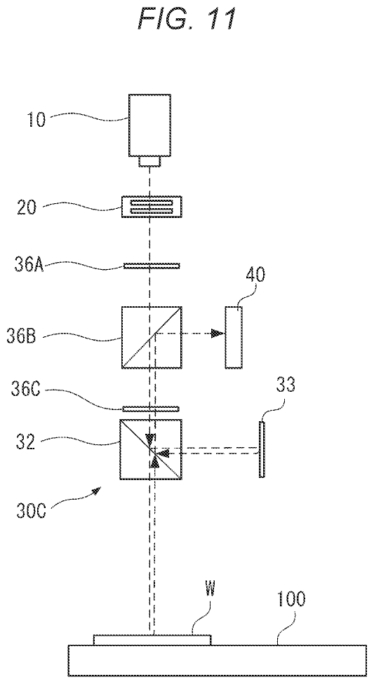

FIG. 11 is a diagram showing a schematic configuration of an interference optical system 30C according to a modified example 2. In FIG. 11, the elevating mechanism 34 or the reference body moving mechanism 35 is omitted.

For example, in the interference optical system 30C shown in FIG. 11, the light transmitted through the spectroscopic element 20 is converted into linearly polarized light (for example, P-polarization) by being incident on a polarization conversion element 36A. The light transmitted through the polarization conversion element 36A is incident on the polarizing beam splitter 36B, and light of the P-polarization is transmitted through the polarizing beam splitter 36B and is emitted toward the beam splitter 32. A λ/4 plate 36C is provided between the polarizing beam splitter 36B and the beam splitter 32, and circularly polarized light transmitted through the λ/4 plate 36C is separated into the measurement light and the reference light by the beam splitter 32 in the same manner as in the above embodiment. In addition, the measurement light reflected by the measurement target W and the reference light reflected by the reference body 33 are made incident on the beam splitter 32 again, combined, and emitted toward the polarizing beam splitter 36B as interference light. Then, the interference light converted from the circularly polarized light to S-polarization by the λ/4 plate 36C is reflected by the polarizing beam splitter 36B and received by the light receiving portion 40.

### Modified Example 3

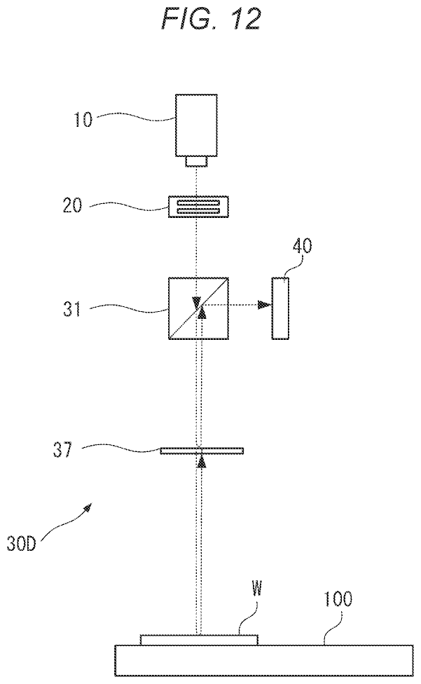

FIG. 12 is a diagram showing a schematic configuration of an interference optical system 30D according to a modified example 3. In FIG. 12, the elevating mechanism 34 is omitted.

In the above embodiment, the beam splitter 32 transmits the measurement light as it is and reflects the reference light toward the reference body 33, thereby separating the light from the spectroscopic element 20 into the measurement light and the reference light, but the present disclosure is not limited to this.

For example, a beam splitter 37 of the interference optical system 30D shown in FIG. 12 has an optical film formed on its surface, which transmits half of the incident light and reflects the other half. In such a beam splitter 37, out of the incident light, the light transmitted through the optical film serves as the measurement light, and the light reflected by the optical film serves as the reference light. That is, the optical film constitutes the reference body of the present disclosure. In this case, interference light is generated by the reference light reflected by the optical film and the measurement light reflected by the measurement target W.

### Modified Example 4

In the above embodiment, the light receiving portion 40 has a plurality of pixels 42, and spectrum information independent of each pixel 42 is acquired, but the present disclosure is not limited to this.

For example, the light receiving portion 40 may receive only the light reflected at a predetermined measurement point of the measurement target W.

In addition, the light receiving portion 40 shows an example in which a plurality of pixels are disposed in a matrix shape on a rectangular light receiving surface 41, but the light receiving portion 40 may be a line sensor in which a plurality of pixels 42 are disposed in a straight line.

### Modified Example 5

The first embodiment shows an example in which the optical path length adjusting unit 52 changes the measurement optical path length ls by controlling the elevating mechanism 34, and the second embodiment shows an example in which the optical path length adjusting unit 52 changes the reference optical path length lr by controlling the reference body moving mechanism 35. On the other hand, both the elevating mechanism 34 and the reference body moving mechanism 35 are provided, and the optical path length adjusting unit 52 may adjust both the elevating mechanism 34 and the reference body moving mechanism 35 to change both the measurement optical path length ls and the reference optical path length lr.

### Modified Example 6

In the first embodiment, in step S11, the measurement optical path length ls is set to the maximum value that can be set by the elevating mechanism 34, the number of peaks of spectrum information at the time when the light receiving signal from the reference pixel reaches the maximum is monitored while reducing the measurement optical path length ls, and the height position of the measurement apparatus 1 at which the number of peaks reaches the minimum is detected.

On the other hand, the measurement optical path length ls may be set to the minimum value that can be set by the elevating mechanism 34, and the number of peaks of the spectrum information may be monitored while increasing the measurement optical path length ls to detect the height position of the measurement apparatus 1 at which the number of peaks reaches the minimum.

The same applies to a case where the reference optical path length lr is changed in the second embodiment.

### Modified Example 7

In the above embodiment, an example in which the spectroscopic element 20 is disposed between the light source portion 10 and the half mirror 31 is shown, but the present disclosure is not limited to this. For example, the spectroscopic element 20 may be provided between the half mirror 31 and the light receiving portion 40.

### Modified Example 8

Examples of the measurement apparatuses 1, 1A, and 1B of the above-described embodiments are apparatuses for measuring the measurement target W placed on the stage 100, but the present disclosure is not limited to this.

For example, the measurement apparatus may be applied to a robot arm provided with an articulated arm or the like. In this case, by providing the measurement apparatus 1, 1A, or 1B at a tip end of the articulated arm, a distance to a work target can be measured by the measurement apparatus 1, 1A, or 1B.

### Overview of Present Disclosure

A measurement apparatus according to the first aspect of the present disclosure is characterized by including a light source portion that emits light, a spectroscopic element that is configured to transmit light of a predetermined wavelength out of the light emitted from the light source portion, and change a predetermined wavelength of the light to be transmitted within a predetermined wavelength range, an interference optical system which separates light emitted from the spectroscopic element into measurement light irradiated on a measurement target and reference light reflected by a reference body, and generates interference light obtained by combining the measurement light reflected by the measurement target and the reference light reflected by the reference body, a light receiving portion that receives the interference light, and a position calculating unit that calculates a position of the measurement target based on spectrum information indicating a change in a received light quantity at the light receiving portion when the wavelength of the light transmitted through the spectroscopic element is changed.

In such a configuration, the spectrum information of the interference light received by the light receiving portion may include a plurality of peak wavelengths, and the optical path length difference between the measurement light and the reference light can be accurately calculated by detecting the peak wavelengths and the peak intervals. Accordingly, even when a foreign matter larger than the wavelength of the interference light is attached to the measurement target, or when irregularities are formed in the measurement target, the size of the foreign matter and irregularities can be calculated with high accuracy.

The measurement apparatus according to the present aspect further includes an optical path length adjusting unit that adjusts an optical path length difference between the measurement light and the reference light, in which the optical path length adjusting unit may adjust the optical path length difference such that the number of peak wavelengths included in the wavelength range of the spectrum information is minimized.

Therefore, an error detection unit can detect an error based on a degree of generation frequency of a wavelength shift with respect to the time at which measurement is performed by the light receiving portion, and can perform error detection more appropriately.

In the spectroscopic apparatus according to the first aspect and the second aspect, an interference filter may include a gap changing unit for changing a gap dimension, and a feedback control unit for feedback-controlling the gap changing unit such that the spectral wavelength detected by a gap sensor approaches a target wavelength.

A condition at which light intensity of the interference light reaches a peak is s=nλ using the measurement optical path length ls, the reference optical path length lr, the degree n, and the wavelength λ. Therefore, when the number of peaks included in the spectral wavelength range reaches the minimum, it means that the degree n is set to the minimum value. By setting such an optical path length difference, the peak wavelength in the spectrum information can be detected with high accuracy, and the measurement accuracy can be improved.

In the measurement apparatus according to the present aspect, the optical path length adjusting unit may change the optical path length of the measurement light.

Therefore, for example, by changing the measurement optical path length while fixing the reference optical path length, the measurement optical path length can be accurately obtained from the value of the optical path length difference calculated by the position calculating unit.

In the measurement apparatus according to the present aspect, the optical path length adjusting unit may change the optical path length of the reference light.

Therefore, for example, by calculating the reference optical path length from the change quantity of the reference body and subtracting the reference optical path length from the value of the optical path length difference calculated by the position calculating unit, the measurement optical path length can be accurately obtained.

In the measurement apparatus according to the present aspect, the light receiving portion may have a plurality of pixels, and the optical path length adjusting unit may change the optical path length difference to a position where the received light quantity reaches a peak when one of a plurality of the pixels is set to a reference pixel and light of a predetermined reference wavelength is received at the reference pixel.

Therefore, with respect to a position of the reference point of the measurement target corresponding to the reference pixel, a position of each measurement point corresponding to the peripheral pixels other than the reference pixel can be accurately calculated.

In addition, when the optical path length difference is adjusted such that the number of peak wavelengths included in the spectrum information of the reference pixel reaches the minimum, a spectrum shape of the spectrum information greatly changes with respect to a spectrum shape of the spectrum information of the reference pixel, when there is a shape change such as a foreign matter or irregularities at the measurement point corresponding to the peripheral pixel. That is, when each measurement point of the measurement target has a shape change due to a foreign matter or the like, the change in the position of the peak wavelength and the peak interval appears remarkably with respect to the spectrum information of the reference pixel. Accordingly, the position of each measurement point of the measurement target can be measured with high resolution.

A measurement method according to the second aspect of the present disclosure in a measurement apparatus including a light source portion that emits light, a spectroscopic element that is configured to transmit light of a predetermined wavelength out of the light emitted from the light source portion, and change a predetermined wavelength of the transmitted light to be transmitted within a predetermined wavelength range, an interference optical system which separates light emitted from the spectroscopic element into measurement light irradiated on a measurement target and reference light reflected by a reference body, and generates interference light obtained by combining the measurement light reflected by the measurement target and the reference light reflected by the reference body, and a light receiving portion that receives the interference light, the measurement method is characterized by including acquiring spectrum information indicating a change in a received light quantity at the light receiving portion when the wavelength of the light transmitted through the spectroscopic element is changed, and calculating a position of the measurement target based on the spectrum information.

Therefore, similarly to the measurement apparatus of the first aspect, even when a foreign matter larger than the wavelength of the interference light is attached to the measurement target, or when irregularities are formed in the measurement target, the size of the foreign matter and irregularities can be calculated with high accuracy.

What is claimed is:

1. A measurement apparatus comprising:
a light source that emits light;
a spectroscopic element that is configured to transmit light of a predetermined wavelength out of the light emitted from the light source portion, and capable of changing the predetermined wavelength of the light to be transmitted within a predetermined wavelength range;
an interference optical system which separates light emitted from the spectroscopic element into measurement light irradiated on a measurement target and reference light reflected by a reference body, and generates interference light obtained by combining the measurement light reflected by the measurement target and the reference light reflected by the reference body;
an image sensor that receives the interference light; and
one or more processors configured to calculate a position of the measurement target based on spectrum information indicating a change in a received light quantity at the light receiving portion when the predetermined wavelength of the light transmitted through the spectroscopic element is changed.

2. The measurement apparatus according to claim 1, further comprising:
an optical path length adjusting unit that adjusts an optical path length difference between the measurement light and the reference light, wherein
the optical path length adjusting unit adjusts the optical path length difference such that a number of peak wavelengths included in the wavelength range of the spectrum information is minimized.

3. The measurement apparatus according to claim 2, wherein
the optical path length adjusting unit changes an optical path length of the measurement light.

4. The measurement apparatus according to claim 2, wherein
the optical path length adjusting unit changes an optical path length of the reference light.

5. The measurement apparatus according to any one of claim 2, wherein
the light receiving portion has a plurality of pixels, and
the optical path length adjusting unit changes the optical path length difference to a position where the received light quantity reaches a peak when one of a plurality of the pixels is set to a reference pixel and light of a predetermined reference wavelength is received at the reference pixel.

6. A measurement method in a measurement apparatus including
a light source that emits light,
a spectroscopic element that is configured to transmit light of a predetermined wavelength out of the light emitted from the light source portion, and capable of changing the predetermined wavelength of the light to be transmitted within a predetermined wavelength range,
an interference optical system which separates light emitted from the spectroscopic element into measurement light irradiated on a measurement target and reference light reflected by a reference body, and generates interference light obtained by combining the measurement light reflected by the measurement target and the reference light reflected by the reference body, and
an image sensor that receives the interference light, the measurement method comprising:
acquiring spectrum information indicating a change in a received light quantity at the light receiving portion when the predetermined wavelength of the light transmitted through the spectroscopic element is changed; and
calculating a position of the measurement target based on the spectrum information.
